(19) United States
(12) Patent Application Publication
(10) Pub. No.: US 2018/0076649 A1
(43) Pub. Date: Mar. 15, 2018

(54) WIRELESS CHARGING APPARATUS

(71) Applicant: Hand E Holder Products, Inc., Ann Arbor, MI (US)

(72) Inventor: Michael Lawrence Burns, Ann Arbor, MI (US)

(21) Appl. No.: 15/705,477

(22) Filed: Sep. 15, 2017

Related U.S. Application Data
(60) Provisional application No. 62/394,919, filed on Sep. 15, 2016.

(51) Int. Cl. H02J 7/02; H01F 38/14; H02J 7/00

(52) U.S. Cl. CPC H02J 7/025; H04N 5/64; H02J 7/0047; H01F 38/14

(57) ABSTRACT

A wireless charging apparatus and a method for making and using a wireless charging apparatus is provided. An embodiment of a wireless charging apparatus system includes at least one inductive coil. The at least one inductive coil may be configured to be disposed within a wireless charging apparatus. In embodiments, a controller may be configured to be connected to the at least one inductive coil. In embodiments, a controller may be configured to be disposed within a wireless charging apparatus. In embodiments, a power supply may be configured to be connected to a controller that may be disposed within a wireless charging apparatus. The power supply may be configured to provide power to at least one inductive coil of a wireless charging apparatus.

### CROSS-REFERENCE TO RELATED APPLICATIONS

This application claims the benefit of U.S. provisional application No. 62/394,919, filed 15 Sep. 2016 (the '919 application). The '919 application is hereby incorporated by reference as though fully set forth herein.

### BACKGROUND

### a. Technical Field

The present disclosure relates to methods and systems for mobile device charging, including a wireless mobile device charging apparatus.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

Wireless charging systems (e.g., inductive), are commonly device-specific. For example, a wireless charging pad provided for a mobile phone may only be configured to receive a mobile phone, or another device sized as, or larger than, a mobile phone (e.g., a tablet computer). The wireless charging pad may also be non-customizable, and may not permit a user to add images and/or designs to personalize the wireless charging pad. Moreover, the wireless charging pads may be limited to receiving the mobile phone horizontally, such as on a table top. Conventional wireless charging pads may not permit the mobile device to be positioned other than horizontally, which may be uncomfortable if a user may desire to use (e.g., view), the device while is it charging. Therefore, a wireless charging device that may accept multiple mobile phones and/or other mobile devices at angles presentable to the user, and/or may permit a user to customize or personalize the cube may be desirable.

The foregoing discussion is intended only to illustrate the present field and should not be taken as a disavowal of claim scope.

### SUMMARY

Embodiments of the present disclosure may include a wireless charging apparatus (e.g., a cube), and a method for making and using a wireless charging apparatus. An embodiment of a wireless charging cube may include at least one inductive coil. The at least one coil may be configured to be disposed within a wireless charging cube. In embodiments, a controller may be configured to be connected to the at least one inductive coil. In embodiments, a controller may be configured to be disposed within a wireless charging cube. In embodiments, a power supply may be configured to be connected to a controller that may be disposed within a wireless charging cube. The power supply may be configured to provide power to at least one inductive coil of a wireless charging cube.

In embodiments, a wireless charging cube (hereinafter “cube”) may include a wireless charging surface configured to selectively engage the portable electronic device, wherein the wireless charging surface includes at least one inductive charging coil, a controller in electronic communication with the at least one inductive charging coil, and a power supply in electronic communication with one or more of the controller and the at least one inductive charging coil. In embodiments, the cube may include a power distribution circuit board. In embodiments, the power distribution circuit board may be programmable. In embodiments, the wireless charging surface may include a transmission module. In embodiments, the transmission module may be in electronic communication with the power distribution circuit board. In embodiments, a second wireless charging surface may be adjacent to the first wireless charging surface, wherein the second wireless charging surface may be in electronic communication with the controller and the power supply. In embodiments, a third wireless charging surface may be adjacent to the first and second wireless charging surfaces, wherein the third wireless charging surface may be in electronic communication with the controller and the power supply. In embodiments, a plurality of wireless charging surfaces may be adjacent to the first, second and third wireless charging surfaces, wherein the plurality of wireless charging surfaces may be in electronic communication with the controller and the power supply. In embodiments, the wireless charging surface may include one or more of a video display and a graphics housing. In embodiments, the graphics housing may be configured to display at least one removable graphical image. In embodiments, the cube may include an ambient light sensor. In embodiments, the cube may include at least one temperature sensor, wherein the at least one temperature sensor may be in electronic communication with one or more of the controller and the power supply. In embodiments, the cube may include a cooling fan in electronic communication with the controller. In embodiments, the controller may be configured to detect, via the at least one inductive charging coil, a presence of the portable electronic device on the wireless charging surface. In embodiments, the cube may include at least one electronic communication port in electronic communication with the controller of the wireless charging surface. In embodiments, the cube may include at least one electronic communication port that may be a universal serial bus (USB) port. In embodiments, the at least one electronic communication port and the controller may be configured to receive software and/or programming updates for wireless charging software stored on one or more of the controller and the portable electronic device. In embodiments, the cube may include at least one light emitting diode (LED) that may be disposed in light communication with the wireless charging surface, may be in electronic communication with the controller and may be configured to emit colored light corresponding to a charging status of the portable electronic device selectively engaging the wireless charging surface. In embodiments, the output of the at least one LED may be determined by one or more of the controller and an ambient light sensor. In embodiments, the at least one LED may be configured to display a first color representative of a first status and a second color representative of a second status.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a perspective view generally illustrating an embodiment of a wireless charging cube in accordance with teachings of the present disclosure.

FIG. 2 is another perspective view generally illustrating an embodiment of a wireless charging cube in accordance with teachings of the present disclosure.

FIG. 3 is another perspective view generally illustrating an embodiment of a wireless charging cube in accordance with teachings of the present disclosure.

FIG. 4 is another perspective view generally illustrating an embodiment of a wireless charging cube in accordance with teachings of the present disclosure.

FIG. 5 is another perspective view generally illustrating an embodiment of a wireless charging cube in accordance with teachings of the present disclosure.

FIG. 6 is another perspective view generally illustrating an embodiment of a wireless charging cube in accordance with teachings of the present disclosure.

FIG. 7 is another bottom view generally illustrating an embodiment of a wireless charging cube in accordance with teachings of the present disclosure.

FIG. 8 is a perspective view generally illustrating an embodiment of a wireless charging cube with a panel removed in accordance with teachings of the present disclosure.

FIG. 9 is a perspective view similar to FIG. 8, generally illustrating an embodiment of a wireless charging cube with transmitter coils removed in accordance with teachings of the present disclosure.

FIG. 10 is a perspective view generally illustrating an embodiment of a wireless charging cube with a panel removed illustrating a power supply in accordance with teachings of the present disclosure.

FIG. 11 is a perspective view generally illustrating an embodiment of a wireless charging cube with a panel removed illustrating a power supply in accordance with teachings of the present disclosure.

FIG. 12 is a perspective view generally illustrating an embodiment of a wireless charging cube with panels removed illustrating a power supply in accordance with teachings of the present disclosure.

FIG. 13 is a perspective view generally illustrating an embodiment of a wireless charging cube with panels removed in accordance with teachings of the present disclosure.

FIG. 14 is a side perspective view generally illustrating an embodiment of a wireless charging cube in accordance with teachings of the present disclosure.

FIG. 15 is a side perspective view generally illustrating an embodiment of a wireless charging cube in accordance with teachings of the present disclosure.

FIG. 16 is a bottom view generally illustrating an embodiment of a wireless charging cube base in accordance with teachings of the present disclosure.

FIG. 17 is a side perspective view generally illustrating an embodiment of a body portion associated with a wireless charging cube base in accordance with teachings of the present disclosure.

FIG. 18 is a side perspective view generally illustrating an embodiment of a wireless charging cube in accordance with teachings of the present disclosure.

FIGS. 19A-19D are perspective views generally illustrating embodiments of a wireless charging cube in accordance with teachings of the present disclosure.

FIGS. 20A-20D are perspective views generally illustrating embodiments of a wireless charging cube in accordance with teachings of the present disclosure.

FIG. 21 is a side view generally illustrating an embodiment of a wireless charging cube including inductive charging coils in accordance with teachings of the present disclosure.

FIGS. 22A-22B are exploded component views generally illustrating embodiments of a wireless charging cube in accordance with teachings of the present disclosure.

### DETAILED DESCRIPTION

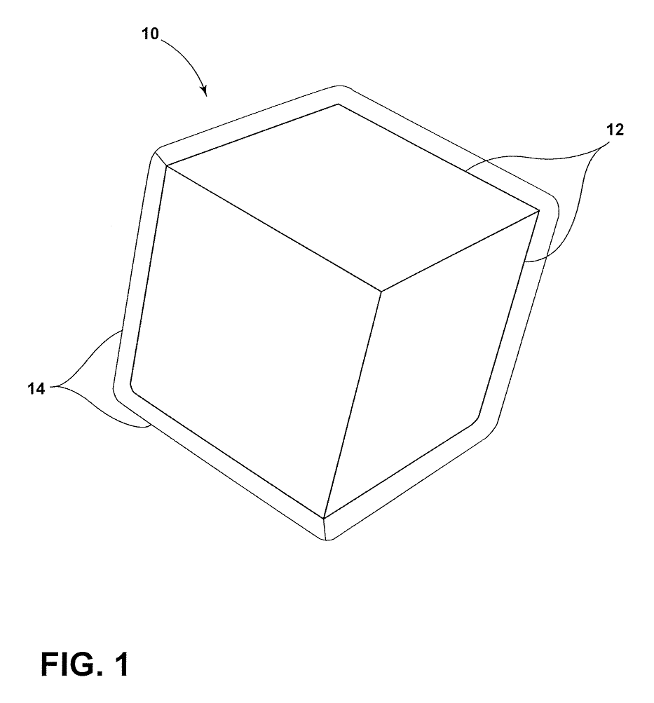

Referring now to the drawings, FIG. 1 generally illustrates an embodiment of a wireless charging device in the form of a cube (e.g., a polyhedron), 10 that may include one or more charging surfaces 12 that each may be at least partially bounded by one or more edges 14. It should be understood that the use of the word cube is exemplary and not limiting. Other multi-sided devices are contemplated, as well as mono-sided devices (i.e., a sphere or ovoid shape). In embodiments of such a device, cube 10 may include (e.g., contain), at least one inductive coil. In embodiments, the at least one inductive coil may be in proximity to one more charging surfaces 12. In embodiments, a controller 32 may be configured to be connected to the at least one inductive coil, and may be configured to be disposed within cube 10. In embodiments, a power supply 28 may be configured to be connected to controller 32 that may be disposed within cube 10. Power supply 28 may be configured to provide power (e.g., electricity), to at least one inductive coil of one or more charging surfaces 12 of cube 10.

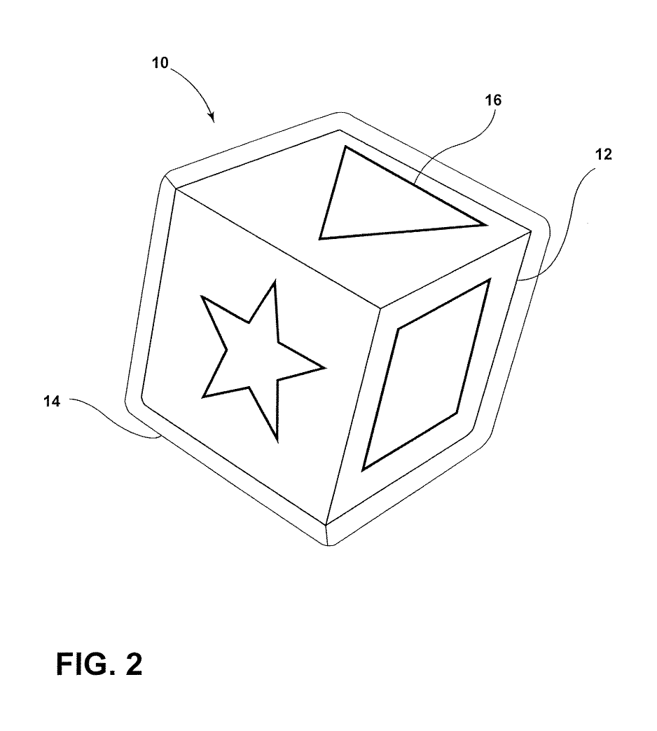

FIG. 2 generally illustrates an embodiment of one or more charging surfaces 12, one or more edges 14, and/or one or more images 16 associated with cube 10. In embodiments, charging surfaces 12 may be oriented orthogonally (e.g., at angles, such as right angles, with respect to each other). In embodiments, charging surfaces 12 may be oriented at other angles. Charging surfaces 12 may be constructed of a material that may be favorable to inductive (e.g., wireless), charging, such as, but not limited to, polymers (e.g., plastic), and/or glass. Charging surfaces 12 may include multiple layers. Charging surfaces 12 may permit images 16 to be located proximate to (e.g., placed between) one or more layers of charging surfaces 12. Additionally and alternatively, images 16 may be configured (e.g., printed, applied), on top of at least a portion of charging surfaces 12. In embodiments, charging surfaces 12 may be insertable, interchangeable, and/or replaceable and may include one or more layers that may display graphics and/or video (e.g., moving images), that may permit images 16 to be displayed on charging surfaces 12 to be customizable and/or changeable. In embodiments, charging surfaces 12 may display slideshows, advertising, and/or other forms of video entertainment and/or information (e.g., games, movies, television, weather, time, and/or calendar). Moreover, in an embodiment, an audio feature, e.g., one or more speakers, may be included on one or more sides or surfaces of cube 10. For example, and without limitation, a speaker (or speaker surface) may be provided in addition to (e.g., on top of), or in place of, one or more of the charging surfaces 12.

In embodiments, panels or charging surfaces 12 may be bounded (e.g., bordered), on at least a portion of at least one side by an edge 14. Edges 14 may be constructed of a moldable material (e.g., plastic, polymers). In embodiments, edges 14 may be configured in sections, such that one or more sections of edges 14 may be joined to another section of charging surface 12, edge 14, and/or base 18. Edges 14 may be configured to support a device, or a portion thereof and may permit or facilitate access to one or more layers of charging surfaces 12. In embodiments, edges 14 may be configured to permit a user to insert image 16 into (e.g., in between), one or more layers of charging surface 12, such as, but not limited to, a photo, sticker, sports card, business card, and/or advertisement.

In embodiments, one or more edges 14 of cube 10 may include and/or be associated with light sources, such as, but not limited to, light emitting diodes (LEDs). In embodiments, one or more edges 14 may be configured to transmit (e.g., display), light from a light source, such as, but not limited to, LEDs. In embodiments, light sources connected to edges 14 may be controlled (e.g., operated), by a controller 32. The controller 32 of cube 10 may activate and/or illuminate (e.g., turn on), light sources associated with edges 14 depending upon operating conditions of cube 10 and/or charging surface 12. For example and without limitation, a controller of light sources of edges 14 may illuminate one or more light sources with a defined color such as “red” to indicate that a device (e.g., mobile phone), placed on or in operational relation with and/or proximity to charging surface 12 may be charging and/or “green” to indicate that a device placed on charging surface 12 may be fully charged. Additionally or alternatively, controller 32 may illuminate the light sources of edges 14 periodically (e.g., blinking), that may indicate a process may have occurred or is occurring (e.g., charging ongoing, incoming phone call, message received). Moreover, the cube 10 may be configured to provide light-sensitive features. For example and without limitation, one or more sensors may monitor an environmental condition (e.g., amount of ambient light), and the cube may adjust one or more associated outputs or displays based upon the sensed condition.

In embodiments, controller 32 may be connected to one or more inductive coils 26 that may be disposed in or within cube 10. In embodiments, controller 32 of cube 10 may include a microprocessor, memory, and/or a communications device. Controller 32 of cube 10 may be configured to operate under inductive charging standards such as, but not limited to, “Qi”, “PMA”, or other inductive charging standards that may exist and/or be developed. It should be understood that controller 32 of cube 10 may be upgradable and/or revisable to operate under one or more inductive charging standards, such as via a flash drive and/or wireless (e.g., Wi-Fi), communication.

In embodiments, controller 32 of cube 10 may include memory to store inductive charging operational standards and/or software (e.g., Qi, PMA standards). In embodiments, a controller may include a communications device to receive and/or send operational standard, software, and/or programming updates. For example, if a new version of an operational standard (e.g., Qi, PMA), is issued, controller 32 may receive the new version (e.g., using an integrated communication device). In embodiments, a communication device (not shown) associated with controller 32 may include a wireless Internet connection (i.e., Wi-Fi), a radio frequency identification (RFID) connection, and/or a communication connection via one or more inductive coils (e.g., transmitting signals to and/or from a device over an inductive power connection). In embodiments, controller 32 may provide information to one or more charging surfaces 12 of cube 10. For example, controller 32 may provide data (e.g., date and/or time, video, images, etc.), to cube 10 and/or one or more charging surfaces 12.

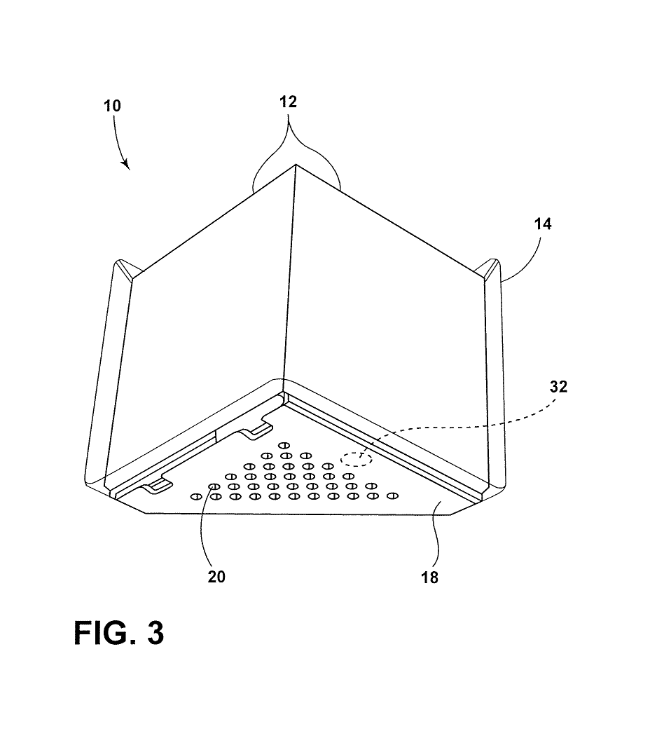

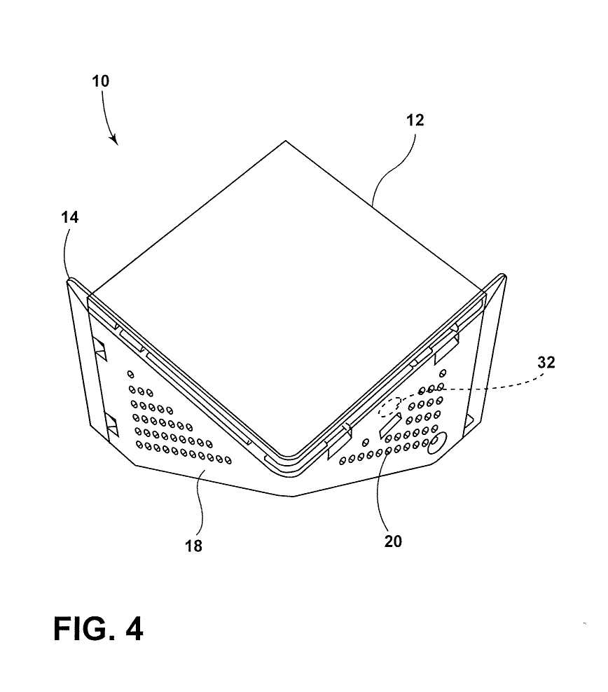

FIGS. 3-4 generally illustrate an embodiment of one or more charging surfaces 12, one or more edges 14, a base 18, and/or vents 20 (i.e., louvers), associated with cube 10. In embodiments, base 18 may be configured to support one or more charging surfaces 12 and/or one or more edges 14. In embodiments, base 18 may include one or more sides (e.g., surfaces), of cube 10. In embodiments, base 18 may be constructed of a moldable material (e.g., plastic, polymers), and/or other suitable materials (e.g., aluminum, carbon fiber, wood). Base 18 may contain controller 32, power supply 28, one or more inductive coils 26 and/or other electronic components of cube 10, as generally illustrated. Base 18 may include vents 20. Vents 20 may be configured at least about base 18 but may also be incorporated in other areas of cube 10, such as, but not limited to, edges of charging surface 12. Vents 20 may permit air flow (i.e., air circulation), at least between the interior and exterior of cube 10. Vents 20 may be connected and/or part of additional one or more cooling devices 34 (e.g., fan, heat sink).

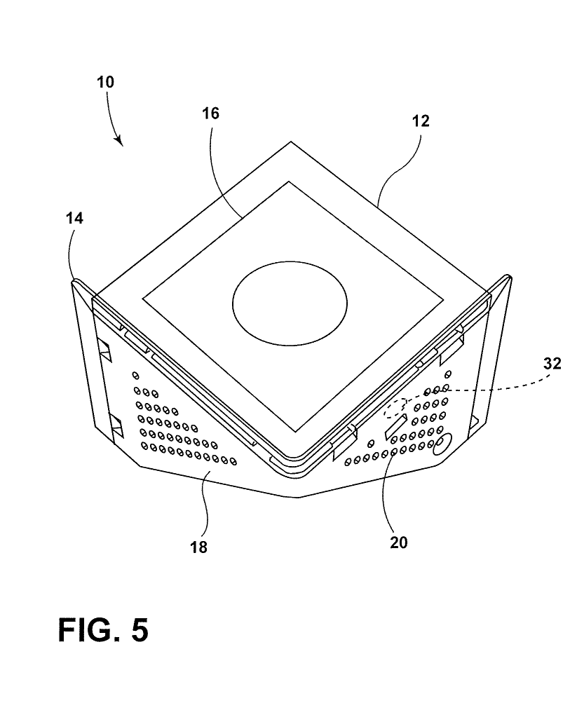

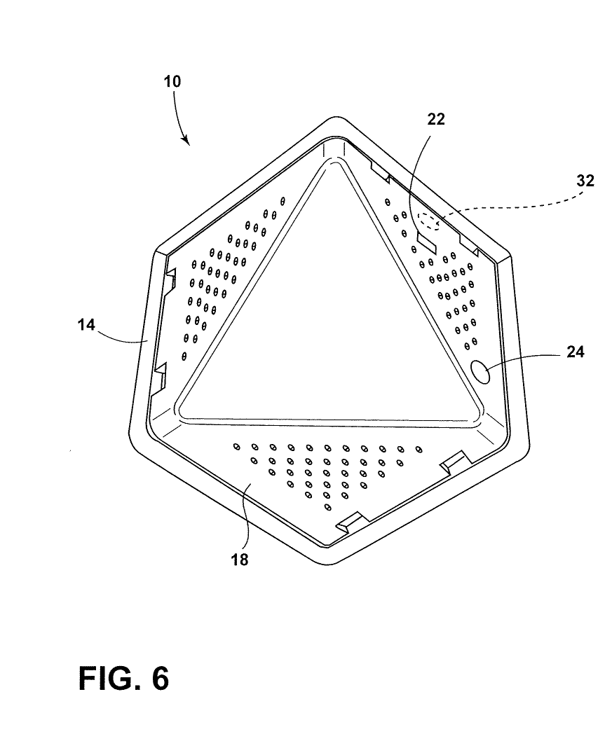

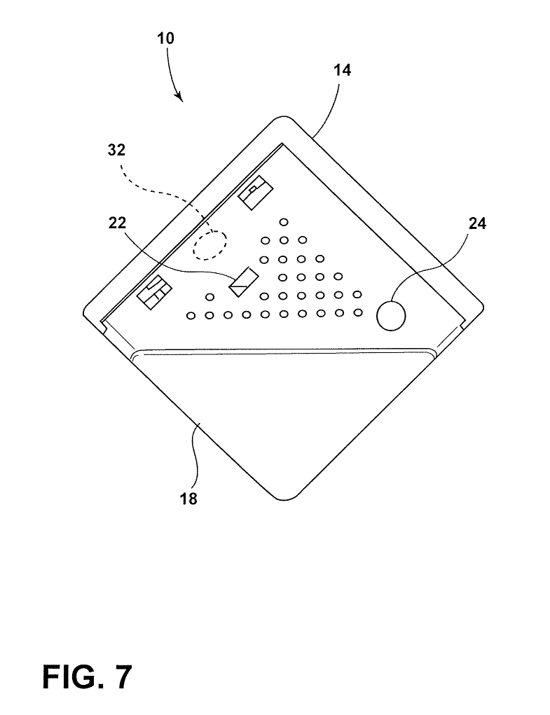

FIGS. 5-7 generally illustrate an embodiment of one or more charging surfaces 12, one or more edges 14, base 18, vents 20, one or more power and/or data ports (e.g., universal serial bus (USB) ports 22), and/or a power port 24 associated with cube 10. If utilized, USB ports 22 may comprise various current or future standards. It should be understood USB ports 22 are exemplary and not limiting. Other types of communication ports are contemplated that may supersede and/or replace USB ports 22. In embodiments, USB ports 22 may be included on one or more surfaces of base 18 of cube 10. In embodiments, power port 24 may be included on one or more surfaces of base 18. In embodiments, at least one surface of base 18 may include other data and/or power ports (e.g., mini-USB, FireWire, etc.), that may be used by mobile devices 30. In embodiments, base 18 may include at least one inductive coil that may receive power from another surface and/or device (e.g., table top, laptop computer, aircraft tray table). In embodiments, one or more edges 14 (or at least portions of edges 14) may be illuminated depending at least upon the condition of USB ports 22 and/or power port 24. For example and without limitation, a portion of edge 14 may be illuminated to indicate that USB ports 22 may be connected to a device, transmitting data, and/or charging.

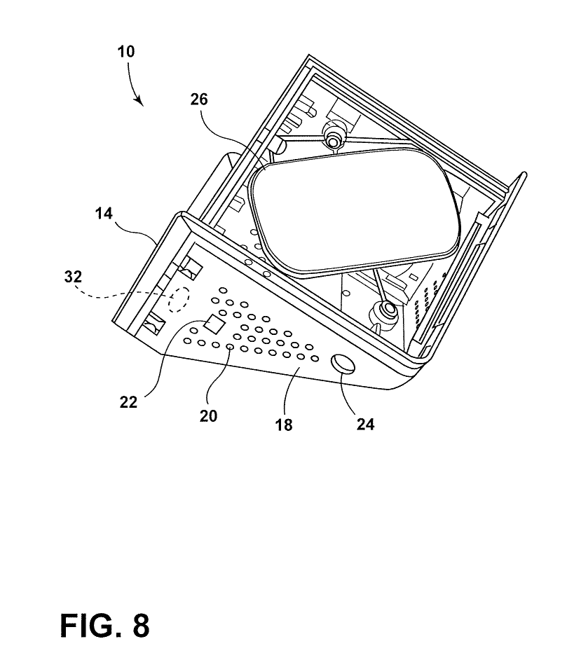

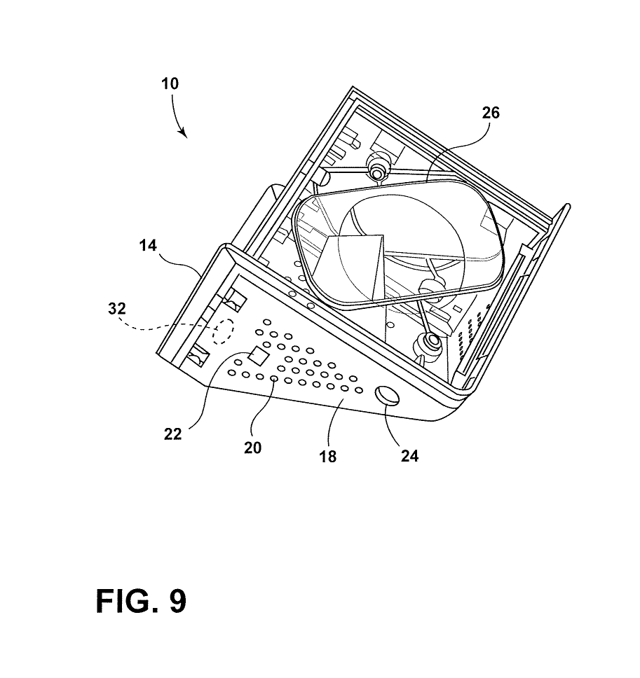

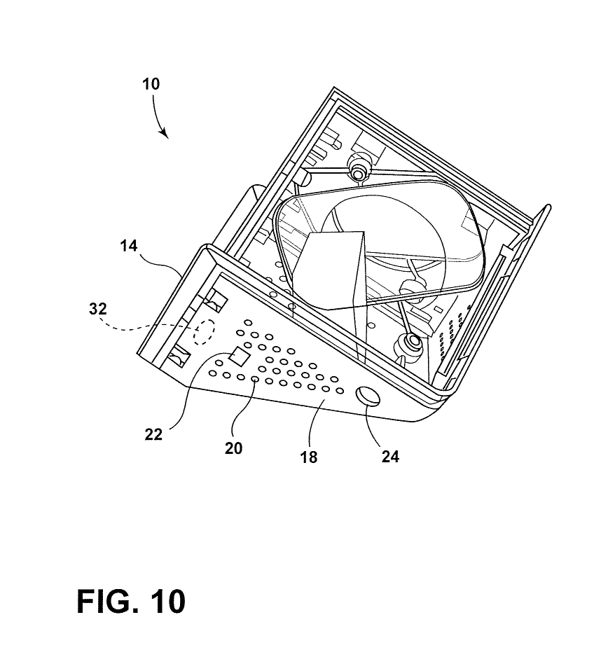

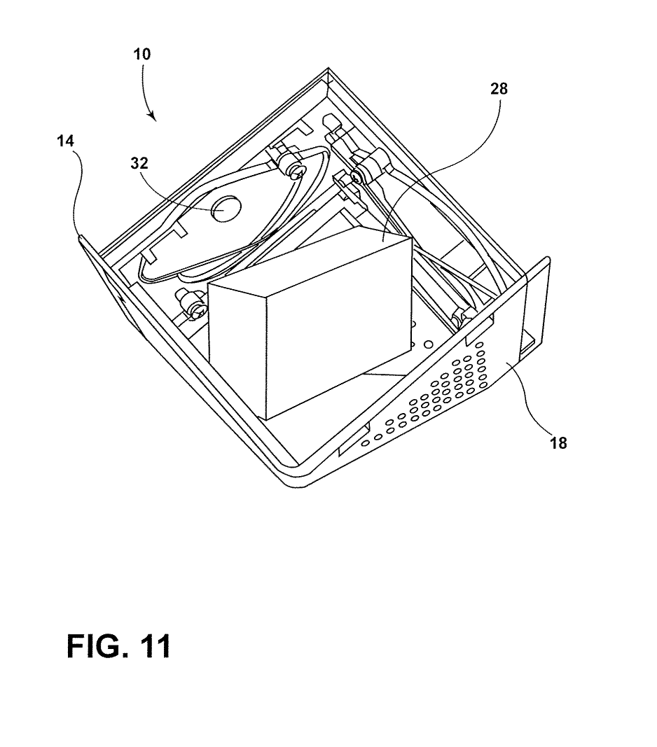

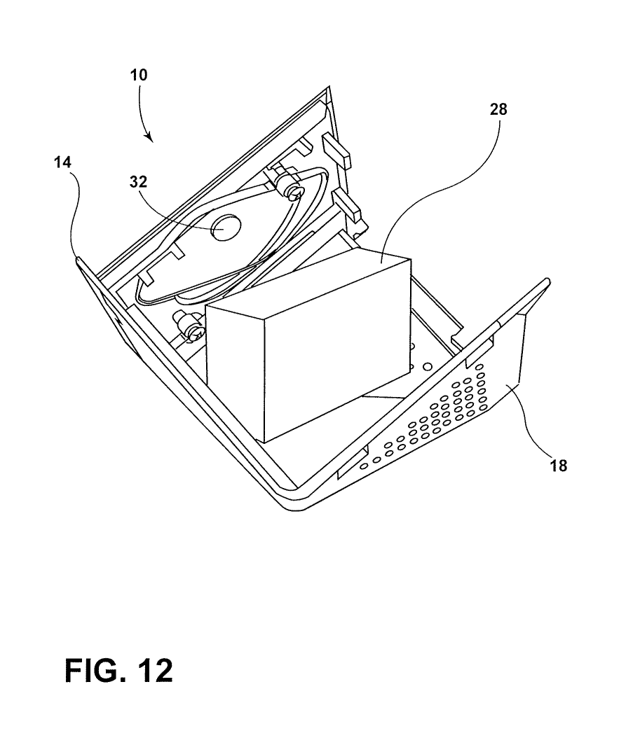

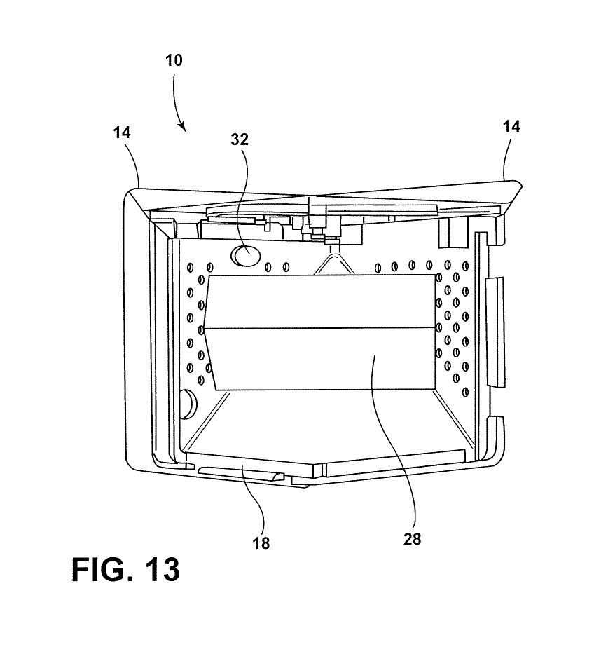

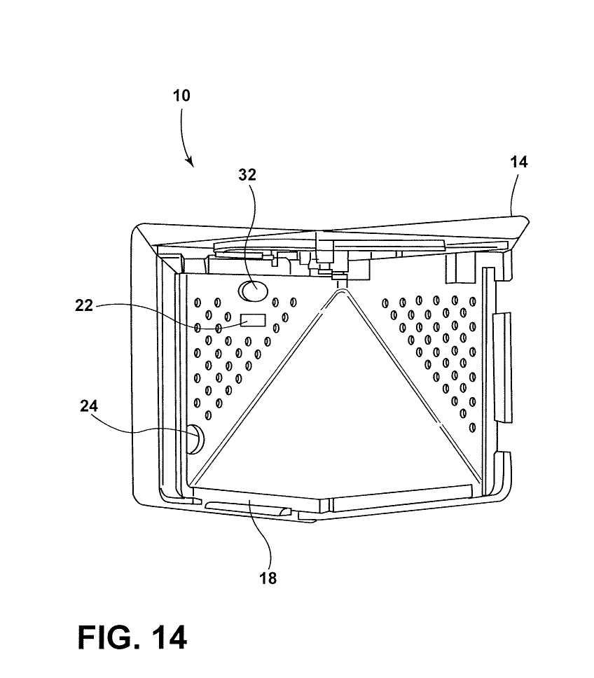

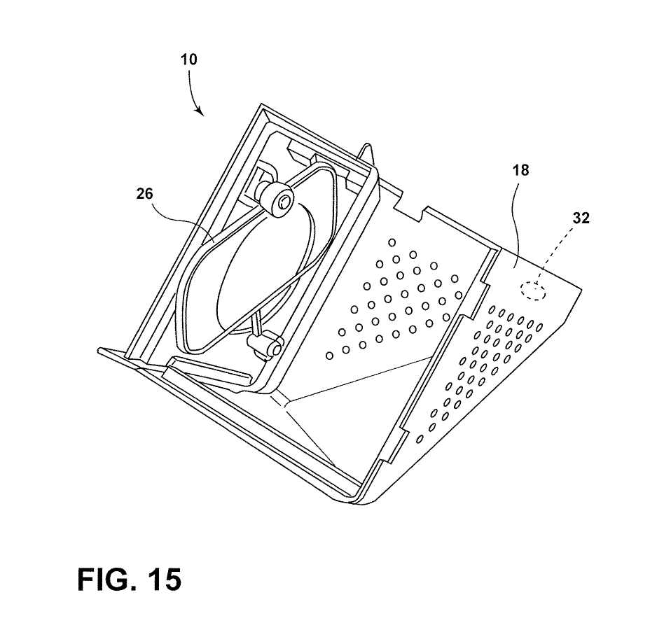

FIGS. 8-15 generally illustrate an embodiment of one or more charging surfaces 12, one or more edges 14, a base 18, vents 20, one or more universal serial bus (USB) ports 22, power port 24, one or more inductive (e.g., wireless), coils 26, and/or a power supply 28 associated with cube 10. While some configurations of inductive coils 26 are illustrated in the drawings, the concept is not so limited, and various other shapes, configurations, and layouts of coils, including those that provided differing surface area coverage, are contemplated. In embodiments, inductive coils 26 may be connected to (e.g., controlled by), controller 32 disposed within base 18. In embodiments, inductive coils 26 may be configured to coincide with (e.g., be positioned to, align with), charging surfaces 12. In embodiments, inductive coils 26 may be disposed between charging surfaces 12 and base 18. In embodiments, inductive coils 26 may be configured to be hidden (e.g., concealed), by charging surfaces 12. In embodiments, inductive coils 26 may be visible through charging surfaces 12. In embodiments, inductive coils 26 may be constructed of conductive material (e.g., copper, aluminum). In embodiments, inductive coils 26 may receive power (e.g., electrical current), via power supply 28. In embodiments, inductive coils 26 may wirelessly transmit (i.e., conduct), power (e.g., 5 W, 15 W), through one or more charging surfaces 12 to one or more mobile devices 30. In embodiments, inductive coils 26 may wirelessly transmit power via resonant inductive coupling. Power supply 28 may be controlled by controller 32 that may be located within base 18 of cube 10. In embodiments, power supply 28 may be integrated with controller 32 within base 18 of cube 10. In embodiments, power supply 28 may connect directly to a power source and/or include a transformer. In embodiments, power supply 28 may include additional components and/or adapters (e.g., European power converters), to accommodate available power sources (e.g., 110V AC, 220V AC, and/or 12V DC). Additionally and alternatively, cube 10 may include a separate transformer and/or other electrical power processing and/or protective equipment (e.g., amplifier, conditioner, surge protector, fuse). Additionally or in lieu of other power methods, cube 10 may include a battery and may be battery-operated, which may, among other things, provide added mobility and portability.

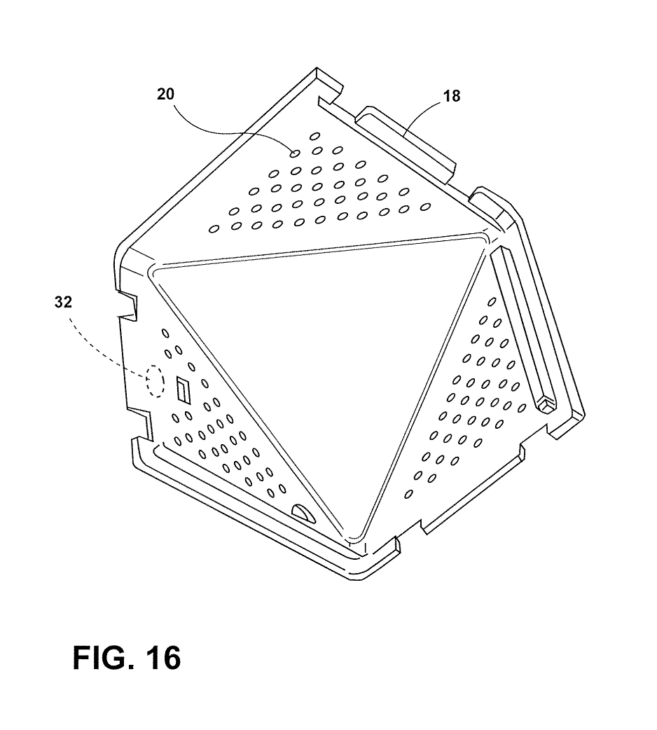

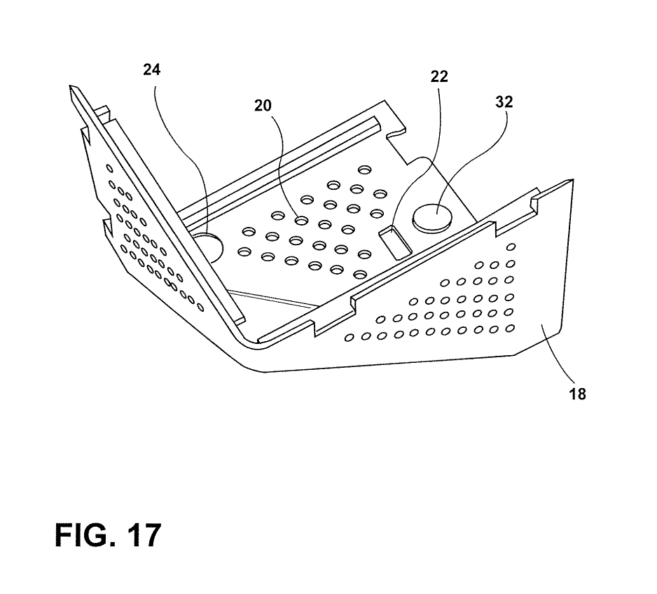

FIGS. 16-17 generally illustrate different views of one embodiment of base 18, vents 20, one or more openings for universal serial bus (USB) ports 22, power port 24, and/or one or more inductive (e.g., wireless), inductive coils 26 associated with cube 10. In embodiments, base 18 may be configured to receive one or more edges 14. In embodiments, base 18 may be configured with one or more surfaces that may include vents 20, USB ports 22 and/or power ports 24.

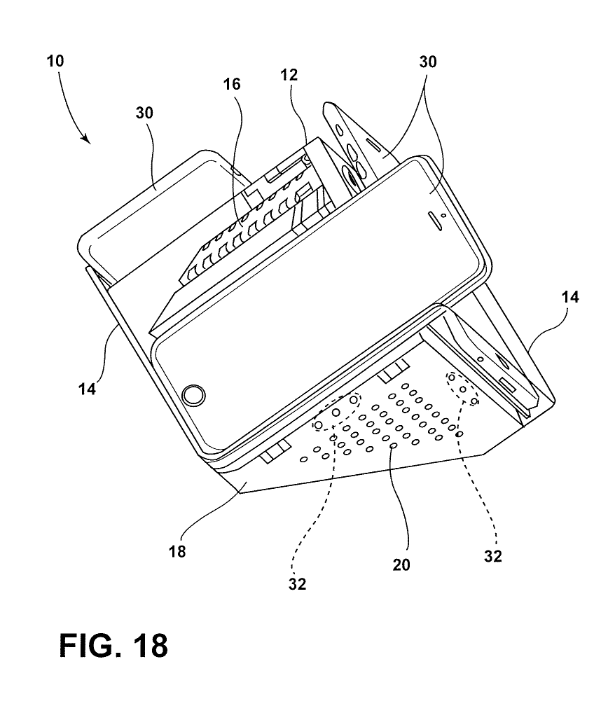

FIG. 18 generally illustrates an embodiment of a wireless charging device in the form of cube 10 coupled with multiple mobile devices 30. In embodiments, the wireless charging device may in the form of a cube 10 and/or polyhedron (i.e., many-sided), that may include one or more charging surfaces 12 that each may be at least partially bounded by one or more edges 14. Charging surfaces 12 may be oriented on one or more angles (e.g., slopes), relative to the horizontal and/or other charging surfaces 12. Cube 10 may include base 18 that may be configured to support one or more charging surfaces 12 and/or edges 14. In embodiments of such a device, cube 10 may include (e.g., contain), at least one inductive coil 26. In embodiments, the at least one inductive coil 26 may be in proximity to one or more charging surfaces 12. In embodiments, controller 32 may be configured to be connected to the at least one inductive coil 26, and may be configured to be disposed within cube 10. In embodiments, controller 32 may be configured to wirelessly (e.g., inductively), charge one or more mobile devices 30 using inductive coupling, such as, but not limited to, resonant inductive coupling. In embodiments, power supply 28 may be configured to be connected to controller 32 that may be disposed within cube 10. Power supply 28 may be configured to provide power (e.g., electricity), to at least one inductive coil of one or more charging surfaces 12 of cube 10. One or more images 16 may be displayed (e.g., projected, inserted), on and/or below one or more charging surfaces 12. One or more mobile devices 30 (e.g., phones, tablet and/or laptop computers), may be disposed on one or more charging surfaces 12 on one or more angles (e.g., 45 degrees), relative to the horizontal and/or one or more mobile devices 30. Light sources (e.g., LEDs), may be disposed in edges 14 and/or base 18. Light sources may be configured to illuminate and/or to activate by a controller to indicate the status of cube 10 and/or mobile devices 30 disposed on cube 10.

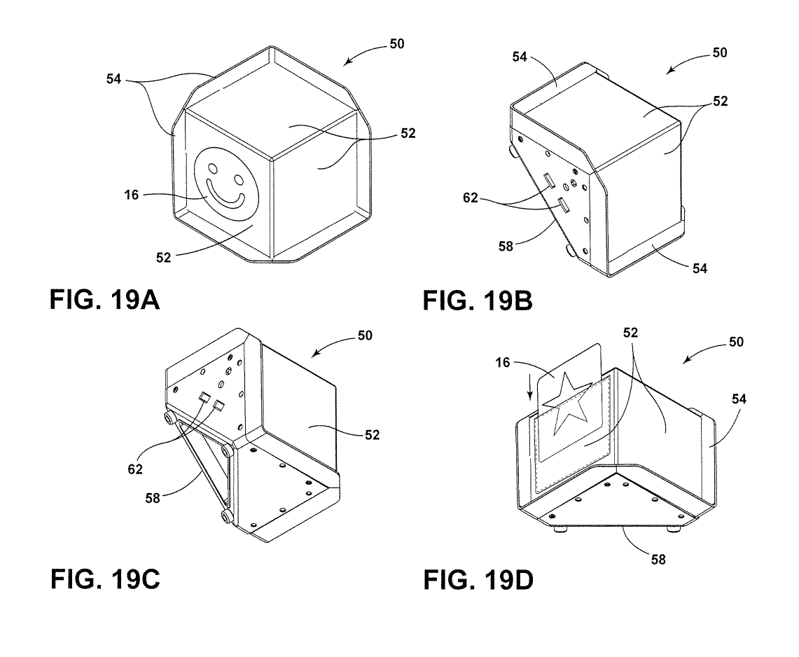

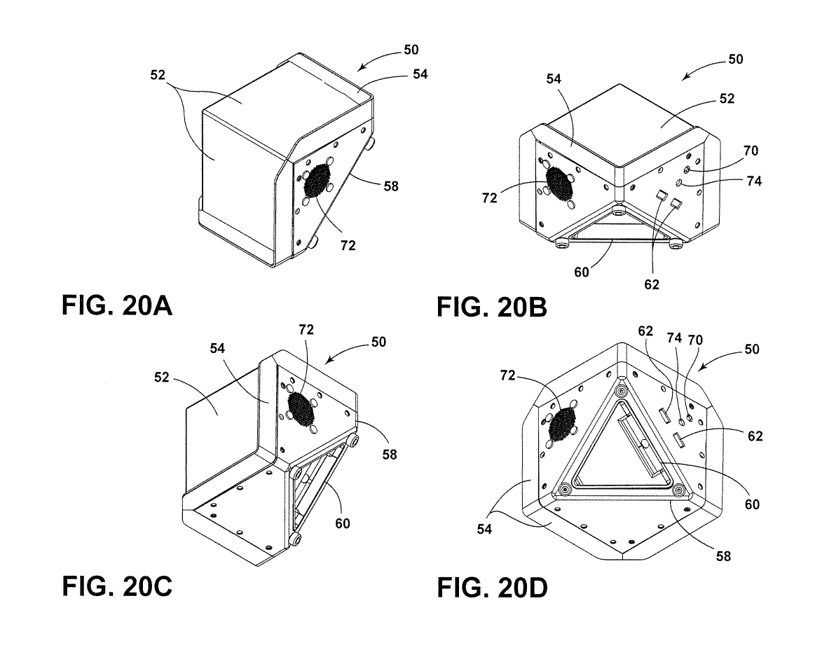

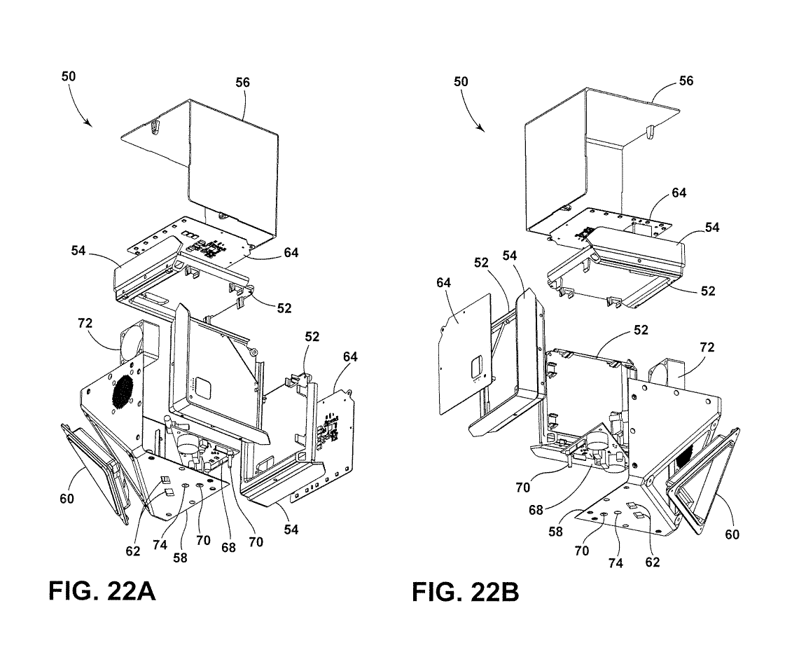

FIGS. 19A-19D, FIGS. 20A-20D, FIG. 21, and FIGS. 22A-22B generally illustrate different perspectives of an embodiment of a wireless charging device in the form of cube 50. In embodiments, the wireless charging device may in the form of a cube 50 and/or polyhedron (i.e., many-sided), that may include one or more light panels 52 (i.e., charging surfaces), that each may be at least partially bounded by one or more light panel edges 54 and at least partially covered by graphics housing 56. Light panels 52 may be oriented on one or more angles (e.g., slopes), relative to the horizontal and/or other light panels 52.

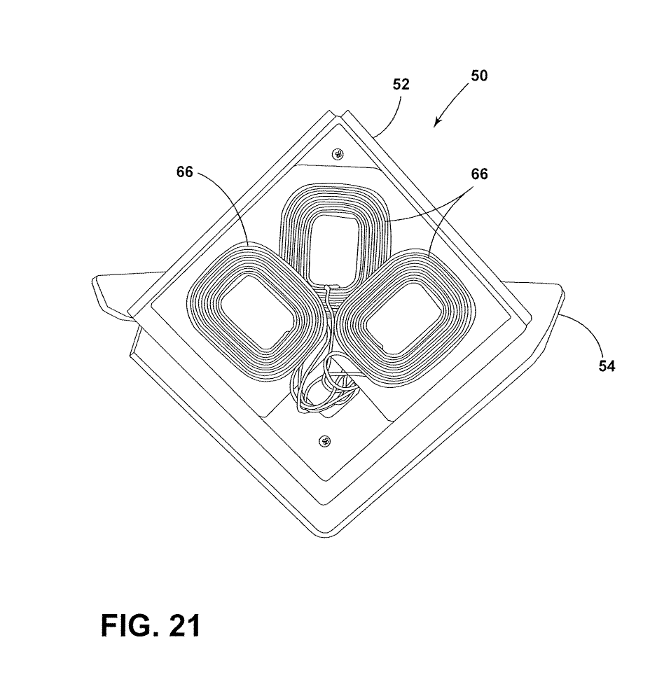

In embodiments of such a device, light panels 52 may include at least one inductive coil 66 (as shown in FIG. 21). It should be understood that the array of inductive charging coils shown is merely exemplary and not limiting. In embodiments, the at least one inductive coil 66 may be in proximity (i.e., adjacent) to one or more light panels 52. One or more images may be displayed (e.g., projected, inserted, printed), on graphics housing 56. In embodiments, graphics housing may include one or more video displays. One or more mobile devices 30 (e.g., phones, tablet and/or laptop computers), may be disposed on light panel edges and/or graphics housing 56 on one or more angles (e.g., 45 degrees), relative to the horizontal and/or one or more mobile devices 30. Light sources (e.g., LEDs (not shown)), may be disposed in light panels 52 and/or light panel edges 54. Light sources may be configured to illuminate and/or to activate by at least power distribution circuit board 68 to indicate the status of cube 50 and/or mobile devices 30 disposed on cube 50 for charging. For example, light sources may illuminate in a green color to indicate charging status, or red for a fault status.

In embodiments, light panels 52 may include one or more transmission modules 64 in electronic communication with inductive coils 66 and/or power distribution circuit board 68. Transmission modules 64 may be configured to regulate (i.e., control), inductive power transmission (i.e., wireless charging), from cube 50 to mobile devices 30 disposed on cube 50. Additionally, transmission modules 64 may be configured to communicate with (i.e., send information to and from), mobile devices 30 via at least inductive power transfer. In embodiments, transmission modules 64 may be configured to receive and/or send electronic communication from (and send to) power distribution circuit board 68, such as, but not limited to, software and/or programming updates for wireless charging software stored on one or more of the controller and the portable electronic device.

In embodiments, a power distribution circuit board 68 (i.e., a controller), may be configured to be connected to the at least one inductive coil 66 (e.g., as shown in FIG. 21), via transmission module 64. In embodiments, power distribution circuit board 68 may be configured to wirelessly (e.g., inductively), charge one or more mobile devices 30 (not shown) disposed on cube 50 using inductive coupling, such as, but not limited to, resonant inductive coupling via transmission module 64. In embodiments, a power supply (not shown) may be configured to be connected to power distribution circuit board 68 of cube 50. In embodiments, the power distribution circuit board may be configured to be programmable to receive and/or send electronic communication from transmission module 64 and/or an external source (i.e., Wi-Fi, a USB storage device, etc.), such as, but not limited to, software and/or programming updates for wireless charging software stored on one or more of the controller and the portable electronic device.

In embodiments, cube 50 includes a base 58. Base 58 may include a seal 60 and one or more USB ports 62. Seal 60 may be configured to engage one or more sides of base 58. It should be understood that USB ports 62 are merely exemplary, and not limiting. Other electronic communication ports (e.g., FireWire), may be substituted or added. Base 58 may include a button 70 and/or an aperture for a button 70 that may be connected to power distribution circuit board 68. Button 70 may be configured to enable a user to program (or reprogram) cube 50. For example and without limitation, a user holding (e.g., pressing down), button 70 for a predetermined period of time (e.g., 30 seconds), may cause power distribution circuit board 68 to enter, for example, a programming (or reprogramming) mode. In embodiments, button 70 may activate and/or deactivate (i.e., turn on or off), the LED feedback for, but not limited to, LEDs mounted on or electronically connected to one or more transmission modules 64. It should be understood that button 70 may be used for additional programming, reprogramming, activation or deactivation functions, and the previous description is exemplary and not limiting.

An ambient light sensor 74 disposed in base 58 and in electronic communication with power distribution circuit board 68 may include a LED. The LED of ambient light sensor 74 may be configured to operate (e.g., flash), while in programming (or reprogramming) mode. Ambient light sensor 74 may also electronically communicate with power distribution circuit board 68 and provide signals relating to the ambient light level surrounding cube 50. For example, ambient light sensor 74 may send a signal to power distribution circuit board 68 to change the output of the light sources of cube 50. In a low-light condition (i.e., night), ambient light sensor 74 may send a signal to power distribution circuit board 68 to decrease the intensity (i.e., brightness), of the light sources of cube 50. Conversely, in a high-light condition (i.e., day), ambient light sensor 74 may send a signal to power distribution circuit board 68 to increase the intensity (i.e., brightness), of the light sources of cube 50.

In embodiments, base 58 may include a fan 72. Fan 72 may be in electronic communication with power distribution circuit board 68 and/or a temperature sensor (e.g., thermistor, not shown). In embodiments, power distribution circuit board 68 may include a temperature sensor. Upon receiving a predetermined temperature signal from the temperature sensor, power distribution circuit board 68 may activate fan 72. For example and without limitation, if the internal temperature of cube 50 exceeds 45 degrees C., power distribution circuit board 68 may activate fan 72. Additionally and alternatively, fan 72 may be in fluid communication with light panels 52 such that air directed by fan 72 may also provide cooling to mobile devices 30 disposed on cube 50 via at least portions of light panels 52.

It is noted that the disclosure is not limited to specific sizes. For example and without limitation, cubes 10, 50 that are intended for use in connection with cell phones or other mobile devices 30 may be sized at or about 3.5 inches (along a length), while cubes 10, 50 sized for tablets (i.e., tablet computers), may be sized at or about 7.5 inches (along a length).

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “embodiments,” “one embodiment,” or “an embodiment,” or the like, means that a particular feature, structure, or characteristic described in connection with the embodiment is included in at least one embodiment. Thus, appearances of the phrases “in various embodiments,” “in embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It should be understood that references to a single element are not so limited and may include one or more of such element. All directional references (e.g., plus, minus, upper, lower, upward, downward, left, right, leftward, rightward, top, bottom, above, below, vertical, horizontal, clockwise, and counterclockwise), are only used for identification purposes to aid the reader's understanding of the present disclosure, and do not create limitations, particularly as to the position, orientation, or use of embodiments.

Joinder references (e.g., attached, coupled, connected, and the like), are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure.

Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

It should be understood that a main electronic control unit (i.e., controller 32 and/or power distribution circuit board 68), as described herein may include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such an electronic control unit may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a computer-readable storage medium having a computer program encoded thereon for implementing at least the wireless charging logic and other functionality described herein. The computer program includes code to perform one or more of the methods disclosed herein. Such embodiments may be configured to execute one or more processors, multiple processors that are integrated into a single system or are distributed over and connected together through a communications network, and where the network may be wired or wireless.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise), are only used for identification purposes to aid the reader's understanding of the present disclosure, and do not create limitations, particularly as to the position, orientation, or use of embodiments. Joinder references (e.g., attached, coupled, connected, and the like), are to be construed broadly and may include intermediate members between a connection of elements and relative movement between elements. As such, joinder references do not necessarily imply that two elements are directly connected/coupled and in fixed relation to each other. Additionally, the terms “electrically connected” and “in electrical communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. An apparatus for a portable electronic device, the apparatus comprising:
a wireless charging surface configured to selectively engage the portable electronic device, wherein the wireless charging surface includes at least one inductive charging coil;
a controller in electronic communication with the at least one inductive charging coil; and
a power supply in electronic communication with one or more of the controller and the at least one inductive charging coil.

2. The apparatus of claim 1, wherein the controller includes a power distribution circuit board.

3. The apparatus of claim 2, wherein the power distribution circuit board is programmable.

4. The apparatus of claim 1, wherein the wireless charging surface includes a transmission module.

5. The apparatus of claim 4, wherein the transmission module is in electronic communication with the power distribution circuit board.

6. The apparatus of claim 1, further comprising a second wireless charging surface adjacent to the first wireless charging surface, wherein the second wireless charging surface is in electronic communication with the controller and the power supply.

7. The apparatus of claim 6, further comprising a third wireless charging surface adjacent to the first and second wireless charging surfaces, wherein the third wireless charging surface is in electronic communication with the controller and the power supply.

8. The apparatus of claim 7, further comprising a plurality of wireless charging surfaces adjacent to the first, second and third wireless charging surfaces, wherein the plurality of wireless charging surfaces are in electronic communication with the controller and the power supply.

9. The apparatus of claim 1, wherein the wireless charging surface includes one or more of a video display and a graphics housing.

10. The apparatus of claim 9, wherein the graphics housing is configured to display at least one removable graphical image.

11. The apparatus of claim 1, further comprising an ambient light sensor.

12. The apparatus of claim 1, further comprising at least one temperature sensor, wherein the at least one temperature sensor is in electronic communication with one or more of the controller and the power supply.

13. The apparatus of claim 1, further comprising a cooling fan in electronic communication with the controller.

14. The apparatus of claim 1, wherein the controller is configured to detect, via the at least one inductive charging coil, a presence of the portable electronic device on the wireless charging surface.

15. The apparatus of claim 1, further comprising at least one electronic communication port in electronic communication with the controller of the wireless charging surface.

16. The apparatus of claim 15, wherein the at least one electronic communication port is a universal serial bus (USB) port.

17. The apparatus of claim 16, wherein the at least one electronic communication port and the controller is configured to receive one of software and programming updates for wireless charging software stored on one or more of the controller and the portable electronic device.

18. The apparatus of claim 1, further comprising at least one light emitting diode (LED) that is disposed in light communication with the wireless charging surface, is in electronic communication with the controller and is configured to emit colored light corresponding to a charging status of the portable electronic device selectively engaging the wireless charging surface.

19. The apparatus of claim 18, wherein the output of the at least one LED is determined by one or more of the controller and an ambient light sensor.

20. The apparatus of claim 19, wherein the at least one LED is configured to display a first color representative of a first status and a second color representative of a second status.
